(19) United States
(12) Patent Application Publication
(10) Pub. No.: US 2012/0260707 A1
(43) Pub. Date: Oct. 18, 2012

(54) Using Nitrogen Containing Fertilizers Recovered from Contaminated Water for Feeding Plants and Algae

(76) Inventor: Gerald J. GROTT, Phoenix, AZ (US)

(21) Appl. No.: 13/158,325

(22) Filed: Jun. 10, 2011

Related U.S. Application Data
(63) Continuation-in-part of application No. 13/087,214, filed on Apr. 14, 2011.

(51) Int. Cl. C05D 9/00

(52) U.S. Cl. 71/54

(57) ABSTRACT

A method of using nitrates, nitrites, or ammonium recovered from contaminated water for feeding plants and algae. If required, the nitrogen waste removed from contaminated waters is treated to be converted as nitrates or nitrites to become readily absorbed by plants and algae. The use of nitrogen containing fertilizer recovered from contaminated waters to feed plants and algae is cost effective for both the process of water decontamination and the growth of plants and algae.

The current application is a continuation-in-part that claims a priority to the U.S. Utility patent application Ser. No. 13/087,214 filed on Apr. 14, 2011.

### FIELD OF THE INVENTION

The present invention relates generally to a method of using nitrogen containing fertilizers recovered from contaminated water for feeding plants and algae. More specifically, the present invention is an efficient and low-cost method of using nitrogen containing fertilizers recovered from contaminated water for feeding plants and algae.

### BACKGROUND OF THE INVENTION

Nitrogen is an essential element in many processes and in life. Nitrogen is used in amino acids, proteins, and is also present in DNA. Large amounts of nitrogen in the form of ammonium, nitrites, nitrates, and other forms of nitrogen containing fertilizer contaminate bodies of water due to natural and unnatural sources. However, the concentration of nitrogen contamination is increasing rapidly due to the human influenced on the natural nitrogen cycle. Natural occurring nitrogen originates from decomposition of animals and plants, natural phenomena including lighting, or animal waste. In a natural nitrogen cycle, such sources of nitrogen are absorbed into the soil and denitrified by existing microbes which feed on nitrogen. Nitrogen waste can exist in the form of nitrates (NO3-) and nitrite (NO2-), which are naturally occurring inorganic ions that are part of the nitrogen cycle. However, due to human influence through the agricultural fertilization, biomass burning, sewage, and other industrial sources, the nitrogen is accumulated in large concentrations and introduced into the nitrogen cycle. Microbial action within the soil or water is able to decompose the organic nitrogen wastes into ammonia, which is then oxidized to nitrates or nitrites. With limited amount of microbes, the large concentrated amount of nitrogen waste is not completely denitrified by the microbial activity. This allows the nitrogen waste to be introduced back into the nitrogen cycle and flow into water bodies. Nitrites are easily oxidized into nitrates and are resultantly predominantly found in waste water. For example, sewage facilities with septic tanks collect and hold large amounts of nitrogen. The collected nitrogen is disposed of by being discharged into a drain field in the ground. The microbial activity in the soil of the drain field consumes the nitrogen and other contaminant from the septic tank waste. However, when the amount of nitrogen and contaminants from the waste is overwhelming, the microbial activity is unable to handle the all of the contaminants. The waste bypasses the microbes and enters a body of water which may be a drinking water source. The nitrogen waste that bypasses the microbes enters and contaminates drinking water. As a result humans drinking the water are placed at risk of poisoning. Another example of nitrogen waste sources from agricultural fertilizing. When crop plants are over fertilized, the plants are unable to utilize all of the nitrogen containing fertilizer. The unused nutrients from the fertilizer are left in the soil and seeps into ground water. In some cases, rain washes off the unused nitrogen and allows the nitrogen waste to flow into water bodies such as streams and rivers. The amount of nitrogen contamination by runoff and drainage from agricultural fields has contaminated the rivers and streams entering the gulf of Mexico. The contamination has reached thousands of square miles. The consequence of such contaminations alters the climate and provides warmer weather where oxygen levels are depleted. Such contaminated areas are called “Dead Zones.”

To ensure that the drinking water is safe for human consumption, water obtained from drinking water sources are treated and filtered of the contaminants. The EPA limit for nitrogen in drinking water is 10 parts per million (ppm). It is necessary to remove any nitrogen contaminant concentrations from drinking water above the 10ppm limit. However, nitrogen is never present in the drinking water in elemental form due to the nitrogen's extremely limited solubility as a gas. Nitrogen is present in water as nitrates or nitrites including calcium, magnesium, sodium, potassium, or even ammonium nitrate or nitrites. Although nitrates and nitrites are used in human bodies are metabolized for amino acids and protein, when consumed at high levels, the highly reactive nitrogen contaminants such as nitrates and nitrites are toxic for humans. At lower levels of concentration, humans digest and convert nitrates to nitrites, which in turn are used in for creating amino acids. In adults, this conversion occurs in saliva. However, in infants, the conversion of nitrates to nitrites occurs in the gastrointestinal track. Infants convert nitrates to nitrate at a rate double of adults. At high levels inside a human body, the nitrates and nitrites are able to enter the bloodstream. Inside the bloodstream, the nitrogen contaminants are able to react with hemoglobin. Hemoglobin is an important protein in blood cells that carries oxygen from the lung to all of the body parts and carbon dioxide from all of the body parts to the lung for exchange. When the nitrites enter the bloodstream, they react with the hemoglobin by oxidizing the iron atoms on the hemoglobin. The oxidation of the iron atoms prevents hemoglobin from being able to carry oxygen. As a result of the accumulation of nitrates in the bloodstream, more and more hemoglobin is rendered unable to receive oxygen from the lungs. The lack of oxygen being supplied to the human's organs causes the human to suffocate.

Nitrogen contaminants such as nitrates are undetectable by color, taste, or smell in the concentrations mixed with water. This is why it is important for water treatment facilities to filter and treat the contaminants from drinking water. To prevent nitrogen waste poisoning, water treatment plants treat the drinking water to remove contaminants including nitrates, sulfates, chlorides, or bicarbonates. Traditional methods of removing contaminants from water include ion exchanges. Ion exchanges are able to treat the contaminants and separate it from the drinking water. The nitrogen waste is separated from the drinking water into a water contaminant brine. In current practice, the water contaminant brine is disposed as waste.

The present invention proposes the method of using the nitrogen extracted from contaminated water for use as nutrients to plants and algae. By using the nitrogen contaminant extracted from the contaminated water, the present invention is able to clean existing water for safe drinking, reduce contamination of other waters through mixing, and reduce air contamination. Additionally, the extraction of nitrates and nitrites from contaminated water offer a cheap option for providing nutrients to plants and algae.

### BRIEF DESCRIPTION OF THE DRAWINGS

FIG. 1 is a flow chart of the present invention where even minute amounts are removed so nitrates and nitrites are removed from contaminated water by means of anion exchange.

FIG. 2 is a flow chart of the method of the present invention where ammonium is recovered by means of cation exchange.

### DETAIL DESCRIPTIONS OF THE INVENTION

All illustrations of the drawings are for the purpose of describing selected versions of the present invention and are not intended to limit the scope of the present invention.

The present invention is the method of using nitrogen containing fertilizers recovered from contaminated water for feeding plants and algae. The present invention utilizes the large amounts of nitrogen waste extracted from contaminated waters in the form of ammonium, nitrites, and nitrates for use as nutrients for plants and algae. Contaminated waters are generally treated and filtered in water treatment plants to ensure cleanliness and safety for drinking

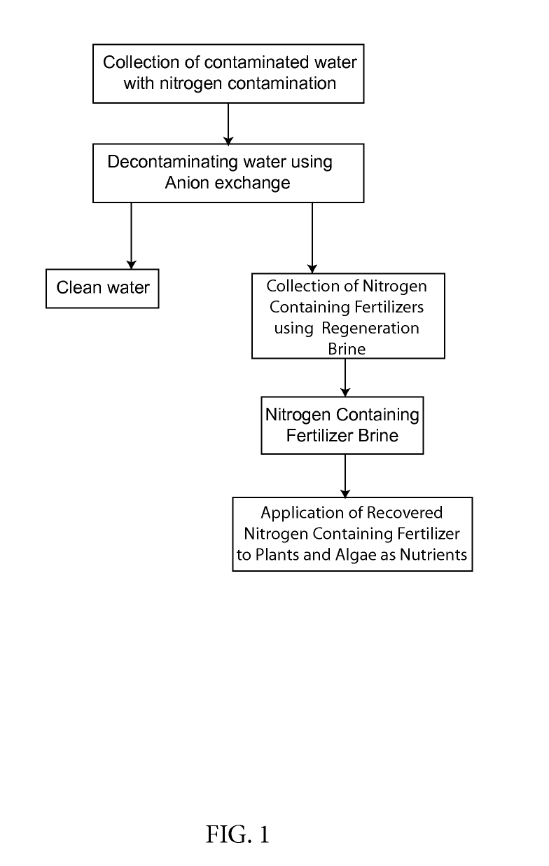

In reference to FIG. 1, to remove the contaminants such as nitrates from the contaminated water, water treatment facilities traditionally use the method of ion exchange. Ion exchange water treatments utilize a bed of ion media to attract and retain the contaminants inside water. The ion resins are insoluble polymer matrixes formed into small beads and/or natural or synthetic Zeolites. The ion resins have a highly developed structure with a plurality of pores on its surface. The pores of the ion resins are sites that are able to easily trap and release ions. The contaminated waters are coursed through a bed of ion exchange media resins while the ion resins attract and retain the contaminants from the passing water. The contaminants are attracted and retained by the ion resins while the ion resins release salt in exchanges for the contaminant. There are two types of standard anion resins that are used to treat drinking water to remove water contaminants. The first type is a resin with ion exchange capabilities derived from a trimethylamine group. The second type of standard anion resin is a resin with a dimethylethanolamine group. These standard anion resins have affinities for the contaminants including sulfate, nitrates, chlorides and bicarbonates. However, these standard anion resins have affinity to other contaminants in relation to nitrate. As a result, the brine obtained from the ion exchange process using the standard anion resins will have concentrations of substances other than nitrates. To obtain brine with a strong concentration of nitrates with lower concentrations of other types of contaminants, nitrate selective resins are used. Nitrate selective resins are able to strongly retain nitrates more than other ions. The nitrate selective resins include functional groups that are placed into the anion exchange media that increases the nitrate affinity. The functional groups included in the nitrate selective anion exchange media makes it difficult for ions other than nitrates to attach themselves to the resin. The anion exchange media with the retained nitrates are treated with regeneration brine. The regeneration brine is generally a sodium chloride brine, but other chloride brines may be used. The sodium chloride brine removes the nitrates from the anion exchange media by means of the sodium chloride exchanging positioned with the nitrates on the resins. The sodium chloride brine is then partially transformed into a nitrate brine. In another embodiment of the present invention, the regeneration brine can be a ammonium hydroxide brine used for the regeneration of anion exchange media to reduce the content of other anions. By using a non-sodium regeneration brine, the resulting sodium concentration of inorganic contents in both the treated clean water and the nitrogen contaminated water is reduced. When the water is made acidic by the exchange of hydrogen with cations. then anion exchanges of hydroxyl (—OH) for chloride and sulfate ions furthers the desalination. (Hydroxyl is obtained by the use of ammonium hydroxide (NH4(OH)) and this material can be used to feed halophytic plants and algae. The nitrogen from the ammonia in the brine is consumed by microbes and the brine can be reused to regenerate ion exchange media to repeat the cycle. Ammonium hydroxide is used to regenerate only weakly basic anions, but weakly basic anions simply adsorbs acids to neutralize the acidity. The weak base resin does not have a hydroxide ion form as does the strong base resin. Consequently, regeneration needs only to neutralize the absorbed acid and does not need to provide hydroxide ions. When the ammonium neutralizes the acids, the resins always pick up anions. Less expensive weakly basic reagents such as ammonia or sodium carbonate can be employed. As a result of the selective ion exchange, a large amount of the sulfate, chlorides, and nitrates that were in the contaminated water ends up in the regeneration brine. The recovery of waste nitrates and nitrites is much of the value of the regeneration brine. All three forms of nitrogen contaminant including nitrates, nitrates, and ammonia is recovered.

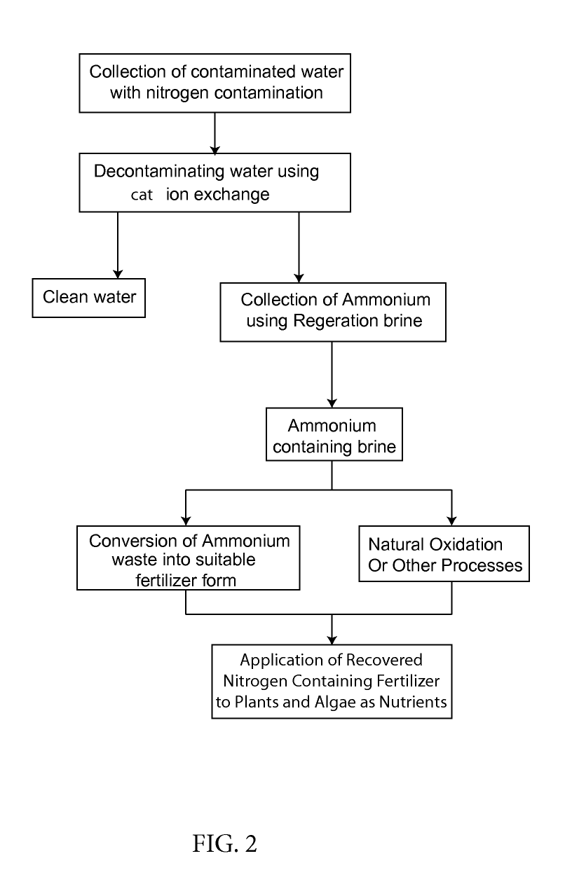

In reference to FIG. 2, when the nitrogen contaminant in the water is in the form of ammonium, the water can be treated by means of a cation exchange media. Although the practice of cation exchange removal of ammonia is only occasionally practiced, this is an option for the present invention for additional nitrogen feed. Cation exchange removal of ammonia is only occasionally practiced primarily due to the lack of used for ammonia in salt water and its cost for disposal. The cation exchange media include Zeolites and cation exchange resins. However, Zeolites are the most used cation exchange media for collecting ammonia from water. The cation exchange media are then treated with a regeneration brine to remove the ammonium. The spent ammonium hydroxide regeneration brine from the removal in nitrates from contaminated water can be reused as the regeneration brine the cation resins from the removal of ammonium.

In the preferred embodiment of the present invention, to ammonia salt(s) is used for the regeneration of the cation exchange media to reduce the content of other cations. An ammonium salt like ammonium chloride or ammonium nitrate is used as regeneration brine in Cation exchange of NH3 for sodium, calcium, magnesium, etc. Not all of the ammonium in the regeneration is exchanged. The remaining ammonium remaining in the regeneration brine can be used as feed for halophytic plants and algae. The nitrogen in the brine is consumed by the microbes and the brine can be reused to regenerate ion exchange media to repeat the cycle. The highly concentrated ammonium brine can be taken directly from water contamination treatment facilities directly to algae crop sites for nutrient application.

In both cation and anion exchanges, the high value features of the use of saline brine for raising halophytic plants and algae is that consumption of the nitrogen by the plants and/or algae conditions the brine for reuse as a regeneration brine. To be able to reuse the brine provides users with the ability to avoid or minimize the need for producing new regeneration brines. As a result, the production costs of the algae and the cost of water treatment is reduced.

The use of the ammonium hydroxides and the ammonium salts for the regeneration of the anion exchange media and the cation exchange media provides for additional nitrogen concentrations in the extracted contaminated water. With a denser concentration of nitrogen containing fertilizer, the resulting contaminated can be applied as nutrients for the growth of plants and algae. With the use of ammonium hydroxides for the regeneration of anion exchange media, the salinity of the resulting water is reduced. With lower salinity, the nitrogen containing fertilizer water will not affect the soil moisture of plants. High salinity of soil can reduce a plants ability to draw and absorb moisture. As a result of lower abilities to absorb water and nutrients from the soil, the growth of the plants is negatively affected.

The reduction of the nitrogen waste in the form of nitrogen containing fertilizer found in water bodies provides for safer drinking water. When consumed at high levels, the highly reactive nitrates and nitrites are toxic for humans. At high levels inside a human body, the nitrates and nitrites are able to enter the bloodstream. Inside the bloodstream, the nitrogen contaminants are able to react with hemoglobin. Hemoglobin is an important protein in blood cells that carries oxygen from the lung to all of the body parts and carbon dioxide from all of the body parts to the lung for exchange. When the nitrites enter the bloodstream, they react with the hemoglobin by oxidizing the iron atoms on the hemoglobin. The oxidation of the iron atoms prevents hemoglobin from being able to carry oxygen. With the accumulation of nitrates in the bloodstream, more and more hemoglobin is rendered unable to receive oxygen from the lungs. The lack of oxygen being supplied to the human's organs causes the human to suffocate.

In addition to safer drinking water, the reduction of nitrates, nitrites, and ammonium in water is beneficial for marine life as well. High levels of nitrates can inhibit growth, impair the immune system and cause stress to marine life. The nitrates that affect marine life originate from surface run off from agricultural or landscaped areas that receive nitrate fertilizer. The nitrates that reach the enclosed bodies of water accumulate and cause death to some of the local aquatic life. This can cause an imbalance to the local ecosystem.

The nitrogen containing fertilizer recovered from the contaminated waters are used to feed plants and algae. Algae can be grown in water or on land. Additionally, algae farms can be placed on land unsuitable for other plants including saline soil. Algae are able to consume carbon dioxide and water for growth. With additional nitrogen containing fertilizer added, the growth period and quantity of algae is improved significantly. Compared to conventional food crops, algae is able to grow 20-30 times faster. With faster growth periods, harvest frequency can be increased for higher production. This application of nitrogen containing fertilizer can significantly reduce the costs of growing algae. By reducing the costs of algae growth, the production of algae can be increased. There are numerous applications for algae, including the use of algae as an alternative energy, the use of algae in scientific studies, pollution control, and the use of algae in foods. In the preferred embodiment of the present invention, the algae can be grown in coal bed methane water. The coal bed methane water is obtained through the extraction of methane from coal deposits. The process of extracting methane from coal beds often involves the pumping of water from the coal bed. The water typically brings both the methane gas and the water up to the surface for treatment. The methane gas and the water used to extract the gas are separated to complete the extraction of the gas. The water used typically is used for reinjection, releasing into streams, irrigation, or processed in evaporation ponds. The water used for methane extraction contain carbon dioxide as bicarbonate. The carbon dioxide can be used to feed algae for growth. The benefit of growing algae in the coal bed methane water is the reduction of alkalinity.

As an alternative energy source, algae can potentially replace the use of fossil fuels. Due to the ability of algae to produce up to 300 times more oil than conventional crops, the viability of having algae oil replacing fossil fuels is higher. However, in order for algae biofuels to replace the traditional fossil fuel, the costs for algae biofuel production must be reduced. The present invention brings the use of algae biofuels to replace fossil fuels closer to reality by reducing production costs. The utilization of nitrogen containing fertilizers extracted from the waste water streamlines and accelerates the algae production process. Additionally, the use of algae as an alternative energy source is a more environmentally friendly option compared to fossil fuels. Algae are able to grow by absorbing carbon dioxide and water. The same carbon dioxide is released back into the atmosphere when the algae biofuel is burned for energy. Although the carbon dioxide is released back into the atmosphere, unlike fossil fuels, no additional carbon dioxide is introduced. Additionally, unlike fossil fuels oils, algae biofuels are biodegradable and is relatively harmless to the environment when spilled.

Algae can also be produced into agar which can be used in many different applications. Agar is a gelatinous substance derived from polysaccharides accumulated in the cell walls of algae. As a gelatinous substance, the agar can be utilized in several applications from microbiological assays to culinary uses. In microbiology, agar is used as an assay medium for the growth of bacteria and fungi. While the gelatinous medium provided can be mixed with nutrition for microbial growth, the gelatinous structure is able to remain intact as most microorganisms are unable to digest agar. Another useful assay using agars is motility assays due to its porous properties. The agar can be used to measure the ability of a microorganism to travel through the agar medium. In other applications agar is also used for electrophoresis assays where separation of large molecules can be observed. In culinary uses, agar is generally used a dessert. As a gelatin, ingredients such as flavorings, fruits, vegetables, or any other suitable edible additions can be suspended into the gelatinous structure of agar to be eaten.

Although the invention has been explained in relation to its preferred embodiment, it is to be understood that many other possible modifications and variations can be made without departing from the spirit and scope of the invention as hereinafter claimed.

1. A method for Using Nitrogen Containing Fertilizers Recovered from Contaminated Water for Feeding Plants and Algae comprising the steps in combination of:
(a) collecting contaminated waters with nitrogen waste;
(b) decontamination processing of the contaminated waters by means of ion exchange, wherein the decontamination process produces a nitrogen waste brine having increased concentration of nitrogen waste and a decontaminated water with decreased concentration of nitrogen waste;
(c) processing of nitrogen waste brine to produce a nitrogen feed mixture; and
(d) applying the nitrogen feed mixture into a plant or a algae crop as nutrients.

2. The method for Using Nitrogen Containing Fertilizers Recovered from Contaminated Water for Feeding Plants and Algae as claimed in claim 1 comprises,
wherein the nitrogen waste comprises nitrates, nitrites, and/or ammonium.

3. The method for Using Nitrogen Containing Fertilizers Recovered from Contaminated Water for Feeding Plants and Algae as claimed in claim 2 comprises,
wherein the ion exchange decontamination process includes the use of a anion exchange media or a cation exchange media.

4. The method for Using Nitrogen Containing Fertilizers Recovered from Contaminated Water for Feeding Plants and Algae as claimed in claim 3 comprises,
wherein the decontamination process is the removal of nitrates and nitrites by means of the ion exchange using anion exchange media; and
wherein the decontamination process is the removal of ammonium by means of the ion exchange using the cation exchange media.

5. The method for Using Nitrogen Containing Fertilizers Recovered from Contaminated Water for Feeding Plants and Algae as claimed in claim 4 comprises,
wherein the nitrogen waste brine is produced by the removal of the nitrate wastes from the anion exchange media and the cation exchange media with a regeneration brine.

6. The method for Using Nitrogen Containing Fertilizers Recovered from Contaminated Water for Feeding Plants and Algae as claimed in claim 5 comprises,
wherein the regeneration brine is a brine selected from the group consisting of a predominantly chloride brine, a ammonium sulfate brine, or a ammonium hydroxide brine.

7. The method for Using Nitrogen Containing Fertilizers Recovered from Contaminated Water for Feeding Plants and Algae in claim 6 comprises,
wherein the regeneration brine is from a water purification process;

8. The method for Using Nitrogen Containing Fertilizers Recovered from Contaminated Water for Feeding Plants and Algae in claim 6 comprises,
wherein the algae is grown in a coal bed methane water to reduce alkalinity of water;
wherein the algae being grown in the coal bed methane water consumes carbon dioxide present in the coal bed methane water;
wherein the regeneration brine is from water used in growing halophytes and/or salt tolerant algae; and
wherein the nitrogen feed mixture is applied and consumed by the halophytes and/or salt tolerant algae to restore the regeneration brine to be reused in the water purification process.

9. The method for Using Nitrogen Containing Fertilizers Recovered from Contaminated Water for Feeding Plants and Algae as claimed in claim 1 comprises,
wherein the contaminated water is collected from a drinking water source.

10. A method for Using Nitrogen Containing Fertilizers Recovered from Contaminated Water for Feeding Plants and Algae comprising the steps in combination of:
(a) collecting contaminated waters with nitrogen waste;
(b) decontamination processing of the contaminated waters by means of ion exchange, wherein the decontamination process produces a nitrogen waste brine having increased concentration of nitrogen waste and a decontaminated water with decreased concentration of nitrogen waste;
(c) processing of nitrogen waste brine to produce a nitrogen feed mixture; and
(d) applying the nitrogen feed mixture into a plant or a algae crop as nutrients.

11. The method for Using Nitrogen Containing Fertilizers Recovered from Contaminated Water for Feeding Plants and Algae as claimed in claim 10 comprises,
wherein the nitrogen waste comprises nitrates, nitrites, and/or ammonium; and
wherein the contaminated water is collected from a drinking water source.

12. The method for Using Nitrogen Containing Fertilizers Recovered from Contaminated Water for Feeding Plants and Algae as claimed in claim 11 comprises,
wherein the ion exchange decontamination process includes the use of a anion exchange media or a cation exchange media;
wherein the decontamination process is the removal of nitrates and nitrites by means of the ion exchange using anion exchange media; and
wherein the decontamination process is the removal of ammonium by means of the ion exchange using the cation exchange media.

13. The method for Using Nitrogen Containing Fertilizers Recovered from Contaminated Water for Feeding Plants and Algae as claimed in claim 12 comprises,
wherein the nitrogen waste brine is produced by the removal of the nitrate wastes from the anion exchange media and the cation exchange media with a regeneration brine; and
wherein the regeneration brine is a brine selected from the group consisting of a predominantly chloride brine, a ammonium sulfate brine, or a ammonium hydroxide brine.

14. The method for Using Nitrogen Containing Fertilizers Recovered from Contaminated Water for Feeding Plants and Algae in claim 13 comprises,
wherein the regeneration brine is from a water purification process;
wherein the algae is grown in a coal bed methane water to reduce alkalinity of water;
wherein the algae being grown in the coal bed methane water consumes carbon dioxide present in the coal bed methane water;
wherein the regeneration brine is from water used in growing halophytes and/or salt tolerant algae; and
wherein the nitrogen feed mixture is applied and consumed by the halophytes and/or salt tolerant algae to restore the regeneration brine to be reused in the water purification process.

15. A method for Using Nitrogen Containing Fertilizers Recovered from Contaminated Water for Feeding Plants and Algae comprising the steps in combination of:
(a) collecting contaminated waters with nitrogen waste;
(b) decontamination processing of the contaminated waters by means of ion exchange, wherein the decontamination process produces a nitrogen waste brine having increased concentration of nitrogen waste and a decontaminated water with decreased concentration of nitrogen waste;
(c) processing of nitrogen waste brine to produce a nitrogen feed mixture; and
(d) applying the nitrogen feed mixture into a plant or a algae crop as nutrients.

16. The method for Using Nitrogen Containing Fertilizers Recovered from Contaminated Water for Feeding Plants and Algae as claimed in claim 15 comprises,
wherein the nitrogen waste comprises nitrates, nitrites, and/or ammonium.
wherein the contaminated water is collected from a drinking water source;
wherein the ion exchange decontamination process includes the use of a anion exchange media or a cation exchange media;
wherein the decontamination process is the removal of nitrates and nitrites by means of the ion exchange using anion exchange media; and
wherein the decontamination process is the removal of ammonium by means of the ion exchange using the cation exchange media.

17. The method for Using Nitrogen Containing Fertilizers Recovered from Contaminated Water for Feeding Plants and Algae as claimed in claim 16 comprises,
wherein the nitrogen waste brine is produced by the removal of the nitrate wastes from the anion exchange media and the cation exchange media with a regeneration brine; and
wherein the regeneration brine is a brine selected from the group consisting of a predominantly chloride brine, a ammonium sulfate brine, or a ammonium hydroxide brine.

18. The method for Using Nitrogen Containing Fertilizers Recovered from Contaminated Water for Feeding Plants and Algae as claimed in claim 17 comprises,
wherein the regeneration brine is from a water purification process;
wherein the algae is grown in a coal bed methane water to reduce alkalinity of water;
wherein the algae being grown in the coal bed methane water consumes carbon dioxide present in the coal bed methane water;
wherein the regeneration brine is from water used in growing halophytes and/or salt tolerant algae; and
wherein the nitrogen feed mixture is applied and consumed by the halophytes and/or salt tolerant algae to restore the regeneration brine to be reused in the water purification process.
